(19) United States
(12) Patent Application Publication
(10) Pub. No.: US 2024/0103449 A1
(43) Pub. Date: Mar. 28, 2024

(54) Dual Display Timer and Its Control Method

(71) Applicant: Xiujun Yang, Ziyang (CN)

(72) Inventor: Xiujun Yang, Ziyang (CN)

(21) Appl. No.: 18/192,181

(22) Filed: Mar. 29, 2023

(30) Foreign Application Priority Data
Sep. 23, 2022 (CN) 202211168329X

(51) Int. Cl. G04G 9/10; G04G 17/02

(52) U.S. Cl. CPC G04G 9/10; G04G 17/02

(57) ABSTRACT

A dual display timer, comprising a main body, a control circuit board and a reminder device; the reminder device and the control circuit board are arranged in the main body and electrically connected; the timer also comprises: a first display area and a second display area; the first and second display areas are disposed on front face of the main body, the first display area comprises an encoder, a plurality of first lamp beads and a first bezel, the second display area comprises a plurality of second lamp beads and a second bezel. Users turn around the rotary axis of the encoder of the first display area, the first lamp beads light up one by one during the turning process, and then dark out one by one as the time runs out, the second lamp beads of the second display area synchronously display the current used time of timing setup.

### 1. TECHNICAL FIELD

The invention belongs to the field of horological technology, and in particular relates to a dual display timer and its control method.

### 2. BACKGROUND ART

A timer is a common small household appliance used to set a fixed time point when a user is studying, exercising or cooking, and a user will be alerted by vibration, sound, or flash when this fixed time point is reached. Timers include mechanical and electronic models. The mechanical model has a better feel for timing but it has the shortage of unclear time display. The electronic timer has a better precision, but it takes more time to set the timing.

The patent of China with the authorized announcement number CN208141133U discloses a dual display timer comprising: an upper cover, a control circuit board, a wheel runner and a lower cover. Said control circuit board and said wheel runner are placed between said upper cover and said lower cover; said control circuit board contains a main control chip, an encoder and a buzzer, and said encoder and said buzzer are electrically connected to said main control chip separately; said encoder has a rotary gear, and said rotary gear meshes with the shaft surface inside said wheel runner. Said patent timer combines partial advantages of mechanical timer and electronic timer, and it has the merit of better feel and clearer time display, but the digital display on the electronic timer becomes unclear at a distance.

The patent of China with the authorized announcement number CN215729321U discloses a countdown timer, which contains a timer body, and said body has the setup of an adapter and a timer, and said adapter and said timer component constitute a circuit of said timer. Said timer component contains an upper composite board, a bracket, a face mount, and a transparent cover connected sequentially. Said bracelet and said face mount are used together to isolate the dispersion of the LED lights on aforesaid upper composite board to form the digital display. This patent overcomes the problem of unclear digital display of electronic timers.

Although the aforesaid prior arts have integrated some advantages of mechanical and electronic timers, they only have the electronic display mode, and only a singular display mode of countdown or count-up, So they cannot meet the preferences of all users, and they fail to get at the same time the remaining time and the used time of timing setup clearly and intuitively. Therefore, it's necessary to improve the prior arts to overcome aforesaid problems.

### 3. SUMMARY OF THE APPLICATION

The object of the invention is to provide a dual display timer and its control method to solve the technical problem in prior arts timers that such timers have singular display mode, and so a user cannot get at the same time the remaining time and the used time of timing setup clearly and intuitively.

For the aforesaid object, an embodiment of the invention provides a dual display timer comprising: a main body, and in this main body there are a control circuit board and a reminder device, and said reminder device is electrically connected to said control circuit board. This embodiment also includes:
A first display area. Said first display area is disposed on the front face of said main body, and said first display area further comprises an encoder, a plurality of first lamp beads and a first bezel; said encoder is disposed on said control circuit board; a plurality of said first lamp beads are arranged to circling said encoder on said control circuit board; said first bezel has a plurality of through-holes arranged in a circling way, and said first bezel is disposed on said control circuit board and makes every said first lamp bead emit light outward through corresponding said through-hole to display digitals;
A second display area. Said second display area is disposed on the front face of said main body. Said second display area comprises a plurality of second lamp beads and a second bezel; a plurality of said second lamp beads are arranged on said control circuit board in the style of digital tubes; on said second display area there are a plurality of slots corresponding to said second lamp beads one by one; said second bezel is disposed on said control circuit board and makes every said second lamp bead emit light outward through corresponding said slots to display digitals.

Optionally, said first bezel and second bezel can be integrally connected as a whole piece.

Optionally, the front end of said main body contains a transparent cover plate, and said transparent cover plate covers said first display area and second display area; said encoder's rotary axis sticks out through said first bezel and said transparent cover plate.

Optionally, said main body contains a battery, and this battery is connected to said control circuit board.

Optionally, said control circuit board contains a main control circuit, a power supply circuit, an encoder circuit, a reminder circuit, a driver circuit and a display circuit; said power supply circuit, said encoder circuit, said reminder circuit, said driver circuit and said display circuit are all connected to said main control circuit; said reminder circuit, said driver circuit and said display circuit are all connected to said power supply circuit; said display circuit is connected to said driver circuit.

Optionally, said main control circuit contains a main control chip, said supply circuit contains said battery, and the twenty-third pin of said main control chip is connected to said battery.

Optionally, said reminder circuit contains said reminder device and a reminder switch, the positive pole of said reminder device is connected to said battery, the negative pole of said reminder device is connected to the collector of said reminder switch, and the base pole of said reminder switch is connected to the third pin of said main control chip.

One or more of the aforesaid technical solutions included in said dual display timer provided by the embodiments of the invention has at least one of the following technical effects:
1. With the main body disposed with a first display area and a second display area, a user turns around the rotary axis of said encoder of said first display area, and said first lamp beads light up one by one during the turning process, and then dark out one by one as the time runs out. At the same time, said second lamp beads of said second display area synchronously display the current used time of timing setup. The invention has the advantages of excellent feel of mechanical timer and clear display of electronic timer;
2. A plurality of first lamp beads are used for display to replace the traditional hand and dial style of display, and so the display is more intuitive and clear. A plurality of second lamp beads are arranged in the style of digital tubes to replace the traditional display style of LED screen or digital tubes, and the display is clearer.
3. Via the countdown of said first display area and the count-up of said second display area, a user can clearly and intuitively know the currently remaining time and used time of timing setup at the same time, and the preferences of various users will be fulfilled.

The invention also provides a control method of dual display timer for the application to said dual display timer, and said control method contains the following steps:
Step S1: Said control circuit board obtains the rotation control data of said encoder, and generates the current timing setup based on said rotation control data;
Step S2: Said control circuit board generates a first control instruction and a second control instruction based on said current timing setup;
Step S3: Said control circuit board sends said first control instruction to said first lamp beads, and controls each said first lamp bead to display said current timing setup based on said first control instruction, then synchronously displays the remaining time of timing setup in the process of counting down to zero from said current timing setup.
Step S4: Said control circuit board sends said second control instruction to said second lamp beads, and controls each said second lamp bead to display zero based on said second control instruction, then synchronously displays the accumulated time of timing setup in the process of counting up to said current timing setup from zero.

Optionally, said control method also includes:
Step S5: Said reminder device will be turned on when the current timing setup runs out.

Optionally, said control method also includes:
Step S6: Said control circuit board obtains a reset command that triggers said encoder,

Optionally, said control method also includes:
Step S7: Said control circuit board sends a reset command to said first lamp beads and said second lamp beads, and controls all said first lamp beads to turn off based on said reset command, while controlling said second lamp beads to display zero based on said reset command.

One or more of the aforesaid technical solutions included in the control method of dual display timer provided by the embodiments of the invention has at least one of the following technical effects:
The rotation control data of said rotary encoder are obtained via said control circuit board, and the current timing setup is generated based on said rotation control data. Then synchronously the remaining time of timing setup is displayed in the process of counting down to zero from said current timing setup through said control circuit board's control of each first lamp bead; synchronously the accumulated time of timing setup is displayed in the process of counting up to said current timing setup from zero through said control circuit board's control of each second lamp bead. A user can clearly and intuitively know the current remaining time and used time of timing setup at the same time, and the preferences of various users will be fulfilled.

### 4. BRIEF DESCRIPTION OF ACCOMPANY DRAWINGS

In order to illustrate the technical solution included in the embodiments of the invention in a clearer way, a simple introduction is provided here to the figures required by the description of embodiments or prior arts. Obviously, the figures stated below are only some embodiments of the invention. For a person with ordinary skills in the art, additional figures can be acquired via these figures without work of creativity.

FIG. 1 is the schematic diagram of the overall structure of a dual-display timer provided by the embodiments of the invention;

FIG. 2 is the schematic diagram of the overall structure of a dual-display timer provided by the embodiments of the invention from another perspective;

FIG. 3 is the decomposed illustration for a dual display timer provided by the embodiments of the invention;

FIG. 4 is the decomposed illustration for a dual display timer provided by the embodiments of the invention from another perspective;

FIG. 5 is the circuit schematic of a dual display timer provided by the embodiments of the invention;

FIG. 6 is the circuit block diagram of a dual display timer provided by the embodiments of the invention;

FIG. 7 is the schematic diagram of the main control circuit of a dual display timer provided by the embodiments of the invention;

FIG. 8 is the schematic diagram of the power supply of a dual display timer provided by the embodiments of the invention;

FIG. 9 is the schematic diagram of the encoder of a dual display timer provided by the embodiments of the invention;

FIG. 10 is the schematic diagram of the reminder circuit of a dual display timer provided by the embodiments of the invention;

FIG. 11 is the schematic diagram of the driver circuit of a dual display timer provided by the embodiments of the invention;

FIG. 12 is the schematic diagram of the display circuit of a dual display timer provided by the embodiments of the invention;

FIG. 13 is the schematic diagram of the keys circuit of a dual display timer provided by the embodiments of the invention;

FIG. 14 is the flowchart of the control method of a dual display timer provided by the embodiments of the invention;

FIG. 15 is the flowchart of the reset steps of the control method of a dual display timer provided by the embodiments of the invention;

In the figures, the marks have the following meaning:
1-main body; 2-control circuit board; 3-first display area; 4-second display area; 5-reminder device; 6-transparent cover plate; 7-battery; 8-function keys; 9-temperature measuring element; 10-encoder; 11-first lamp beads; 12-first bezel; 13-through-hole; 14-second lamp beads; 15-second bezel; 16-slots; 17-third lamp beads; 18-charging interface; 100-main control circuit; 200-power supply circuit; 300-encoder circuit; 400-reminder circuit; 500-driver circuit; 600-display circuit; 610-switch circuit; 700-key circuit.

### 5. SPECIFIC EMBODIMENT OF THE APPLICATION

The embodiments of the invention are detailed below. The examples of these embodiments are illustrated by the figures, and the marks remain the same or similar from beginning to end indicate the same or similar elements, or the elements with the same or similar functions. The embodiments illustrated by the figures are for exemplary purpose, and they are intended to be used as explanations, and not the limitations on the invention.

In the description of the embodiments of the invention, it is necessary to understand that the orientations or locations indicated by the terms “length”, “width”, “up”, “down”, “front”, “back”, “left”, “right”, “vertical”, “horizontal”, “top”, “bottom”, “inside”, “outside” are for the illustration of the figures, and they are only for the convenience and simplification of the description of the embodiments of the invention, that they have no indication or implication that pertinent device or element must have a specific orientation or location, or their construction or operation must be at a specific orientation or location, and so these marks are not limitations on the invention.

Additionally, the terms “first”, “second” are only for descriptive purpose, and they shall not be understood as indicating or implying relative importance, or implicitly expressing the quantity of indicated technical features. Therefore, the features defined as “first”, “second” may explicitly or implicitly include one or more features. In the description of the embodiments of the invention, the term “plurality” means two or more, unless there is another express and particular definition.

In the embodiments of the invention, unless otherwise expressly specified and explained, the terms “install”, “connected”, “connect”, “fix” shall be understood in a broad sense. For example, to be connected can be connected in a fixed way, or connected in a removable way, or connected as a whole piece; and such connection can be mechanical or electrical, direct or indirect via an intermediate medium; and the connection can also means that two elements have internal connection or the two elements have a relationship of interaction. For a person of ordinary skills in the art, the particular meaning of aforesaid terms in the embodiments of the invention can be understood depending on a particular context.

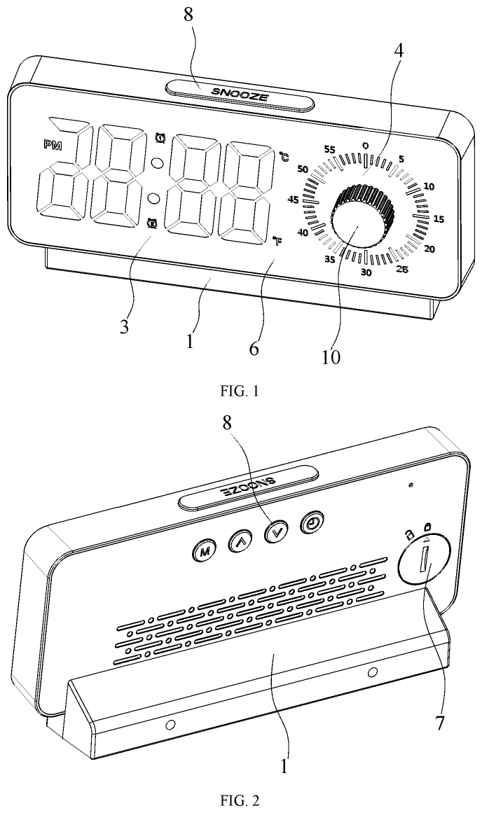

As shown in FIG. 1 and FIG. 2, an embodiment of the invention provides a dual display timer which contains a main body 1, a control circuit board 2, a first display area 3, a second display area 4 and a reminder device 5. Said control circuit board 2 is disposed in said main body 1, and said first display area 3 and said second display area 4 are disposed at the front face of said main body, said reminder device 5 in said main body 1.

The front end of said main body 1 contains a transparent cover plate 6, and said cover plate 6 covers said first display area 3 and said second display area 4. Said transparent cover plate 6 can be made of glass, acrylic and other transparent materials. Said main body 1 is provided with a battery 7, and said battery 7 is connected to said control circuit board 2 to power the components on said control circuit board. In this embodiment, said battery 7 is a memory battery, so that said control circuit board 2 can still continue to clock after shutdown, and there's no need to re-adjust the clock after re-booting. Said main body 1 is provided with a plurality of function keys 8.

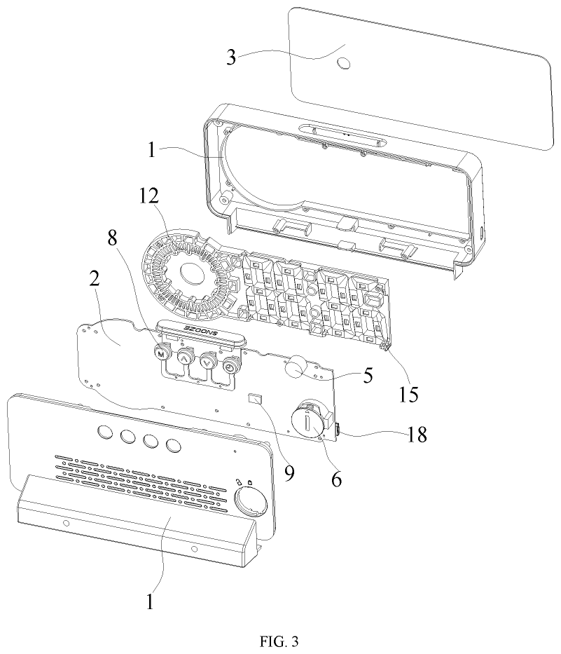

It should be noted that the use of battery as power supply in this embodiment is only an example, and this use of battery does not mean said main body 1 must be powered by a battery. As an alternative, as shown in FIG. 3, the charging interface 18 can also be provided on main body 1, and said control board 2 within said main body 1 can be powered using charging cables of the models such as Typce-C, micro Typce-C or Typc-B. As an alternative, said charging interface 18 and said battery 7 can also be provided simultaneously on said main body 1.

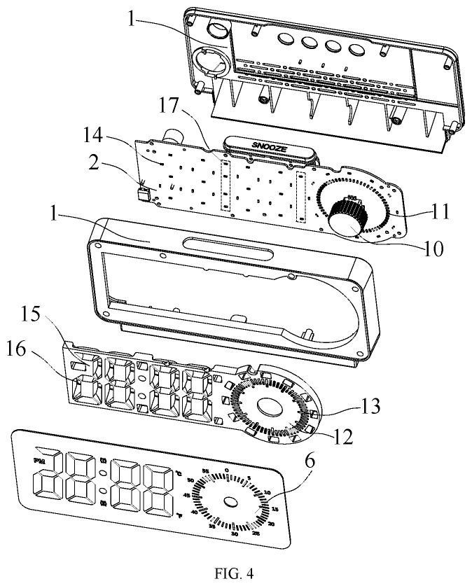

Said control circuit board 2 is provided with a temperature measuring element 9, as shown in FIG. 3, and the ambient temperature measured by said temperature measuring element 9 can be displayed by said second display area 4. A user can switch between Celsius and Fahrenheit via the function key 8, and the temperature measurement range of said temperature measuring element 9 is −10° C.˜50° C. (14° F.˜122° F.). As shown in FIG. 4, said first display area 3 is disposed on the front face of said main body 1, and said first display area 3 includes an encoder 10, a plurality of first lamp beads 11 and first bezel 12.

Said encoder 10 is disposed on said control circuit board 2. In this embodiment, when said encoder 10 rotates one cycle, said first display area 3 reaches the maximum timing setup of 1 hour.

A plurality of said first lamp beads 11 surrounding said encoder 10 are arranged on said control circuit board 2.

Said first bezel 12 has a plurality of through-holes 13 arranged in a cycling way and equally spaced, said first bezel 12 is disposed on said control circuit board 2 and makes said first lamp beads 11 emit light outward through said corresponding through-holes 13. The rotary axis of said encoder 10 sticks out through said first bezel 12 and said transparent cover plate 6. In this embodiment, a plurality of said through-holes 13 are arranged in a cycling way forming the shape of a circular dial, and the numbers of said through-holes 13 and said first lamp beads 11 are both 60. When the timing work is carried out, the rotary shaft of said encoder 10 is turned around, and said first lamp beads 11 light up one by one; and whenever a first lamp bead 11 lights up, it represents a minute increase in the timing setup. In this embodiment, said through-hole 13 for indicating special time scales (0, 5, 10, 15, 20, . . . 50, 55) is distinguished from said through-holes 13 indicating other time scales. At the same time, said through-holes 13 can be additionally provided next to the side of said through-hole 13 indicating a special time scale, and corresponding said first lamp beads 11 can be added to enable a user to know better the current timing setup.

As shown in FIG. 4, said second display area 4 is disposed on the front face of said main body 1, said second display area 4 includes a plurality of second lamp beads 14 and a second bezel 15.

A plurality of said second lamp beads 14 are arranged on said control circuit board 2 in the style of digital tubes, and the program in the chip on said control circuit board 2 makes a plurality of said second lamp beads 14 display digitals in accordance with the working principle of digital tubes. Said second bezel 15 is provided with a plurality of slots 16 corresponding to said second lamp beads 14 one by one, and said second beads 15 are disposed on said control circuit board 2 and make each said second lamp bead 14 emit light outward through said corresponding slot 16 to display digitals.

Said reminder device 5 is a buzzer, it can also be a flash, a vibration motor, a speaker, etc., which are not limited.

Of this figure, said dual display timer not only has the function of a timer, but also has a variety of functions via the program in the main control chip U1 disposed on said control circuit board 2, so that said dual display timer has the functions of digital clock and alarm light. A user can set date, time and alarm clock via said function key 8, and when the timing function is not turned on, said second display area 4 displays the current date and time, and it is capable of shifting between 12-hour and 24-hour clocks. At the same time, said control circuit board 2 is provided with a plurality of third lamp beads 17; said third lamp beads 17 display Fahrenheit, Celsius, alarm clock, AM, PM, etc. as the additional function of said dual display timer.

In another embodiment of the invention, as shown in FIG. 3-FIG. 4, said first bezel 12 and said second bezel 15 are integrally connected as a whole piece. Said first bezel 12 is circular, and said second bezel 15 is rectangular. Said first bezel 12 and said second bezel 16 can be disposed at left and right, at up and down, or can be disposed in an overlapped way, not limited.

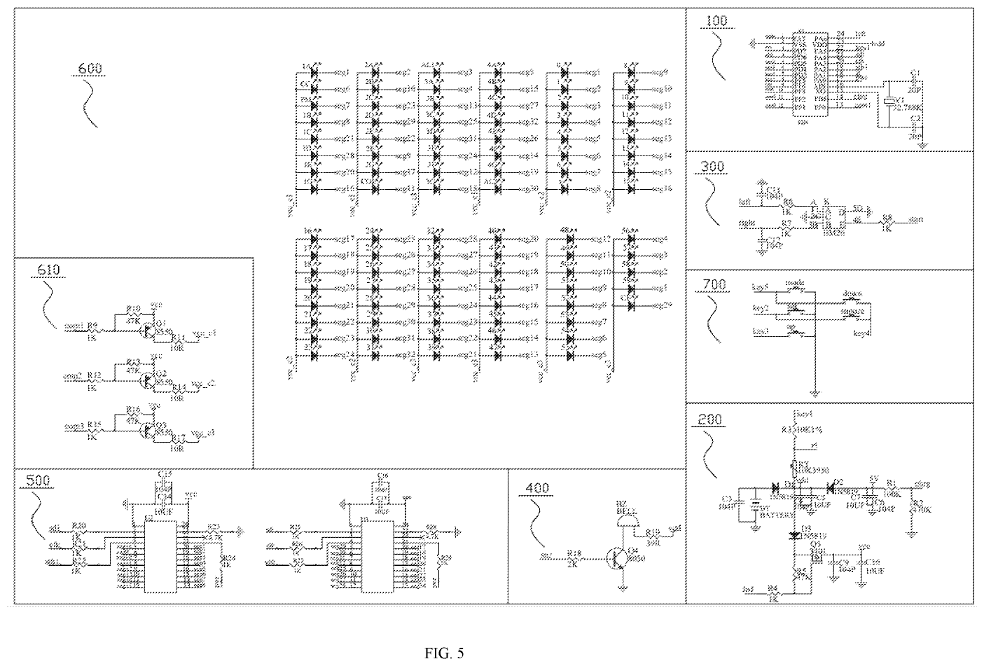

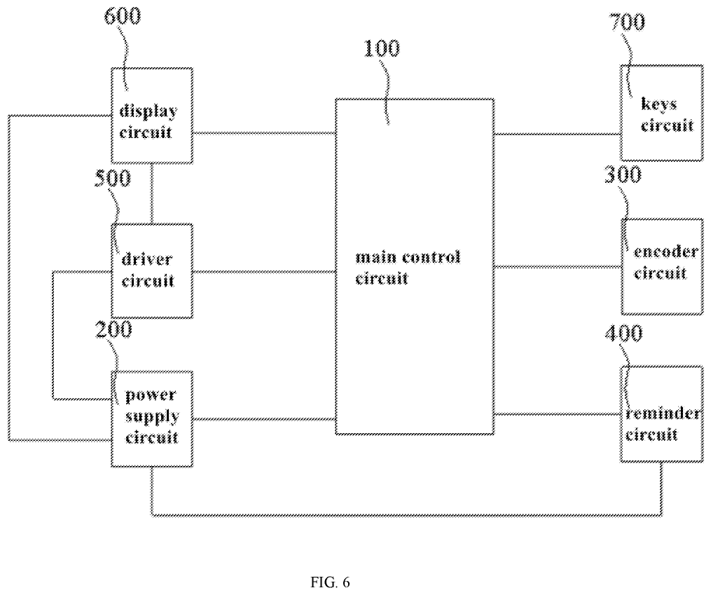

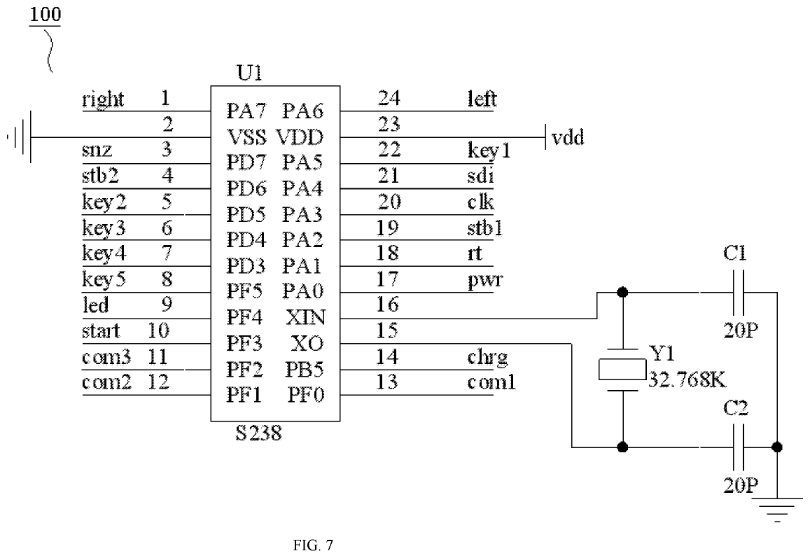

In another embodiment of the invention, as shown in FIG. 5-FIG. 6, said control circuit board 2 is provided with a main control circuit 100, a power circuit 200, an encoder circuit 300, a reminder circuit 400, a driver circuit 500 and a display circuit 600. Said power supply circuit 200, said encoder circuit 300, said reminder circuit 400, said driver circuit 500 and said display circuit 600 are connected to said main control circuit 100. Said reminder circuit 400, driver circuit 500 and said display circuit 600 are all connected to said power supply circuit 200. Said display circuit 600 is connected to said driver circuit 500.

As shown in FIG. 7, said main control circuit 100 includes a main control chip U1, and the model of said main control chip U1 is preferably DCT026, or other chips of the same type.

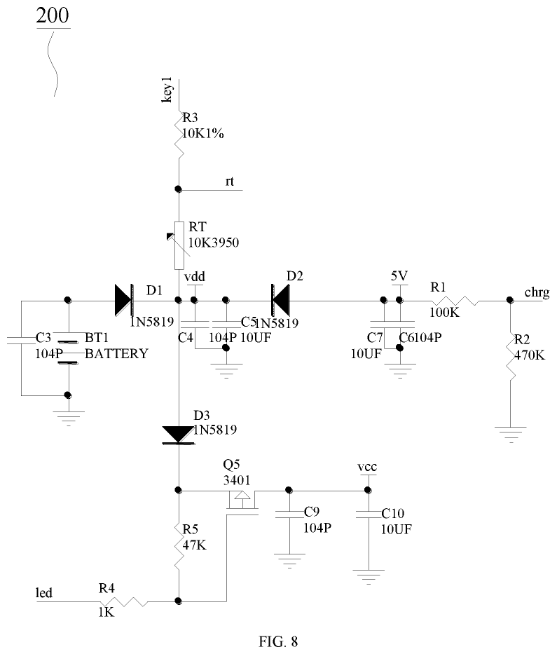

Said power circuit 200 includes said battery 7, a first power supply pole Vdd, a power switch Q5 and a second power supply pole Vcc. Said battery 7 is marked as BT1 in the circuit schematic shown in FIG. 8, and said battery 7 is connected to said first power supply pole Vdd. The twenty-third pin of said main control chip U1 is connected to said battery 7 and said first power supply pole Vdd. The source pole of said power switch Q5 is connected to said battery 7 and said first power supply pole Vdd, the grid of said power switch Q5 is connected to the ninth pin of said main control chip U1, and the drain of said power switch Q5 is connected to said second power supply pole Vcc. Said power supply circuit 200 further comprises said temperature measuring element 9 for measuring the current ambient temperature, and said temperature measuring element 9 is marked as RT in the circuit schematic shown in FIG. 8. One end of said temperature measuring element 9 is connected to the eighteenth pin of said main control chip U1, and the other end of said temperature measuring element 9 is connected to said first power supply pole Vdd.

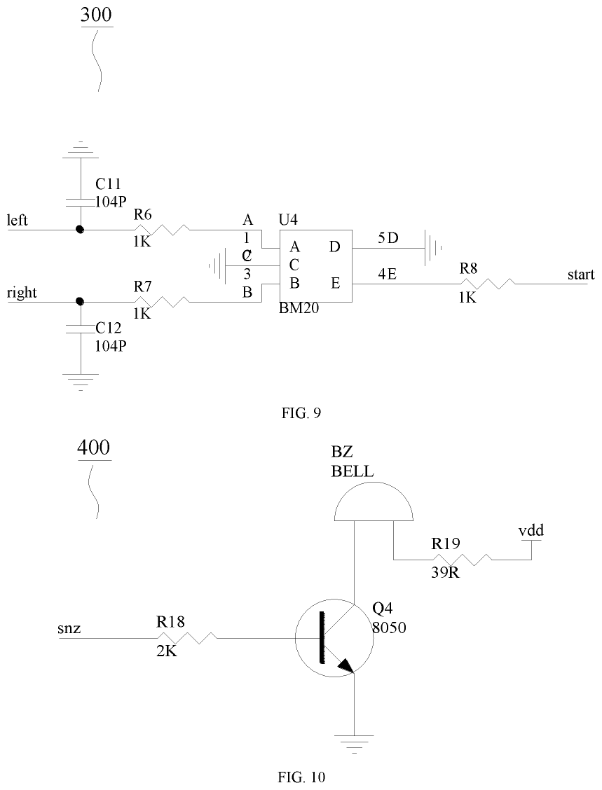

Said encoder circuit 300 includes said encoder 10; said encoder 10 is marked as U4 in the circuit schematic diagram shown in FIG. 9; the first pin of said encoder 10 is connected to the twenty-fourth pin of said main control chip U1; the third pin of said encoder 10 is connected to the first pin of said main control chip U1; and the fourth pin of said encoder 10 is connected to the tenth pin of said main control chip U1.

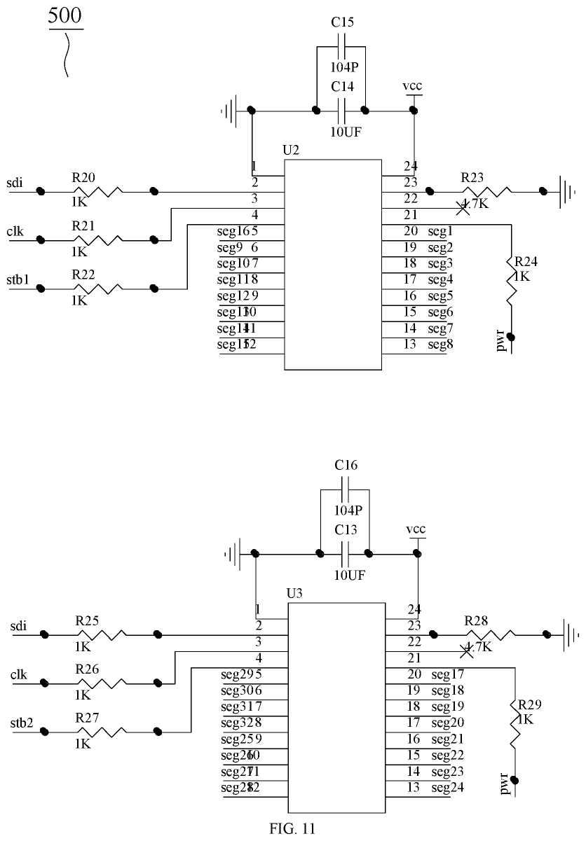

Said reminder circuit 400 includes said reminder device 5 and a reminder switch Q4; said reminder device 5 is marked as BZ in the circuit schematic diagram shown in FIG. 10; the positive pole of said reminder device 5 is connected to said battery 7 and said first power supply pole Vdd; the negative pole of said reminder device 5 is connected to the collector of said reminder switch Q4; and the base pole of said reminder switch Q4 is connected to the third pin of said main control chip U1.

Said driver circuit 500 can adjust the display brightness of said second lamp beads 14 to adapt to different scenarios of day and night. As shown in FIG. 11, said driver circuit 500 includes a first driver chip U2 and a second driver chip U3. The second pin of said first driver chip U2 is connected to the twenty-first pin of said main control chip U1; the third pin of said first driver chip U2 is connected to the twentieth pin of said main control chip U1; the fourth pin of said first driver chip U2 is connected to the nineteenth pin of said main control chip U1; the twenty-fourth pin of said first driver chip U2 is connected to the second power supply pole Vdd, and the twenty-first pin of said first driver chip U2 is connected to the seventeenth pin of said main control chip U1. The second pin of said second driver chip U3 is connected to the twenty-first pin of said main control chip U1; the third pin of said second driver chip U3 is connected to the twentieth pin of said main control chip U1; the fourth pin of said second driver chip U3 is connected to the nineteenth pin of said main control chip U1; the twenty-fourth pin of said second driver chip U3 is connected to the second power supply pole Vdd, and the twenty-first pin of said second driver chip U3 is connected to the seventeenth pin of said main control chip U1. The model of said first driver chip U2 and said second driver chip U3 is preferably CA1302, or other chips of the same type.

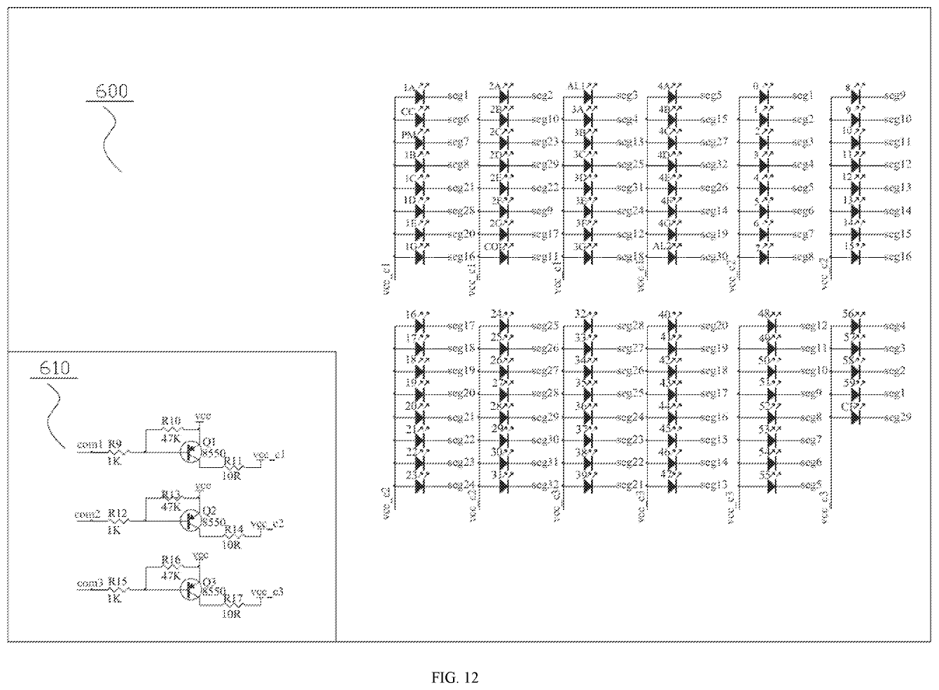

As shown in FIG. 12, said display circuit 600 includes a plurality of said first lamp beads 11, a plurality of said second lamp beads 14, a plurality of said third lamp beads 17 and a switching circuit 610. A plurality of said first lamp beads 11 are connected to said first driver chip U2, said second driver chip U3 and said switch circuit 610; a plurality of said second lamp beads are connected to said first driver chip U2, said second driver chip U3 and said switch circuit 610; a plurality of said third lamp beads 17 are connected to said first driver chip U2, said second driver chip U3 and said switch circuit 610. Said switch circuit 610 includes a first switch Q1, a second switch Q2 and a third switch Q3. The base pole of said first switch Q is connected to the thirteenth pin of said main control chip U1; the base pole of said second switch Q2 is connected to the twelfth pin of said main control chip U1; the base pole of said third switch Q3 is connected to the eleventh pin of said main control chip U1. The specific method for connecting said first lamp beads 11, said second lamp beads 14, said third lamp beads 17 to said first driver chip U2, said second driver chip U3 and said switch circuit 610 should be known to a person skilled in the art, and are not further elaborated herein.

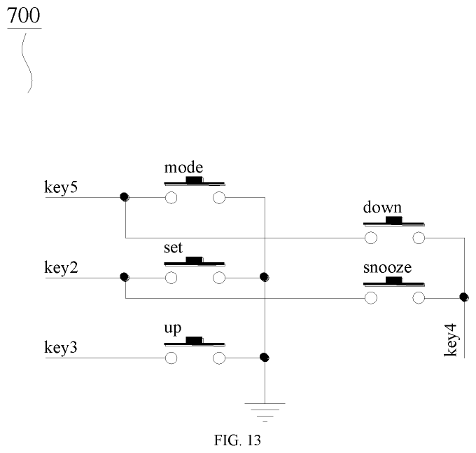

Said control circuit board 2 further comprises a key circuit 700; said key circuit 700 includes a plurality of function keys 8 for switching of a variety of functions, and the number of said function keys 8 is five, respectively marked as first key ‘mode’, second key ‘set’, third key ‘up’, fourth key ‘down’, fifth key ‘snooze’ in the circuit schematic diagram shown in FIG. 13. Said first key ‘mode’, second key ‘set’ and third key ‘up’ are co-grounded at one end; the other end of said first key ‘mode’ is connected to the eighth pin of said main control chip U1, the other end of said second key ‘set’ is connected to the fifth pin of said main control chip U1, and the other end of said third key ‘up’ is connected to the sixth pin of said main control chip U1. One end of said fourth key ‘down’ is connected to the eighth pin of said main control chip U1, one end of said fifth key ‘snooze’ is connected to the fifth pin of said main control chip U1, and the other end of said fourth key ‘down’ and the other end of said fifth key ‘snooze’ are connected to the seventh pin of said main control chip U1.

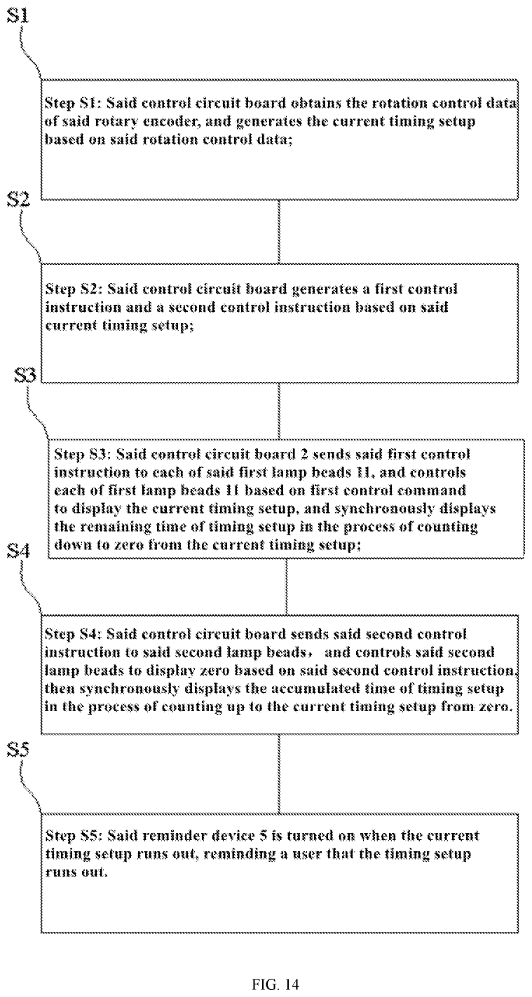

In another embodiment of the invention, as shown in FIG. 14, a control method of dual display timer is provided and applied to aforesaid dual display timer; said control method comprises the following steps:

Step S1: Said control circuit board 2 obtains the rotation control data of said encoder 10, and generates the current timing setup based on said rotation control data.

A user turns said encoder 10 to generate angular displacement; said encoder 10 generates an electrical signal based on the angular displacement, and converts this electrical signal into a counting pulse (i.e., rotation control data) and then sends it to said control circuit board 2.

Step S2: Said control board 2 generates a first control instruction and a second control instruction based on the current timing setup.

Step S3: Said control circuit board 2 sends said first control instruction to said first lamp beads 11, and controls first lamp beads 11 based on first control command to display the current timing setup, and synchronously displays the remaining time of timing setup in the process of counting down to zero from the current timing setup;

Step S4: Said control circuit board 2 sends said second control instruction to said second lamp beads 14, and controls said second lamp beads 14 to display zero based on said second control instruction, then synchronously displays the accumulated time of timing setup in the process of counting up to the current timing setup from zero.

When the said steps S3 and S4 are carried out, said step S1 can be carried out again to change the current timing setup, and then new step S3 and step S4 can be carried out sequentially.

Step S5: Said reminder device 5 is turned on when the current timing setup runs out, reminding a user that the timing setup runs out.

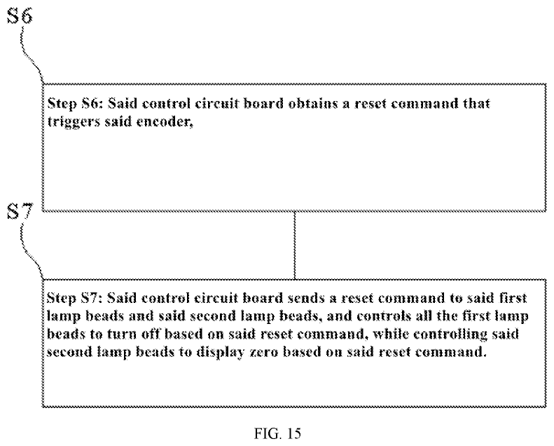

Another embodiment of the invention, as shown in FIG. 15, further includes the following steps for resetting the current timing setup:

Step S6: Said control board 2 obtains a reset command that triggers said encoder 10.

Step S7: Said control board 2 sends a reset command to said first lamp beads 11 and said second lamp beads 14, and controls said first lamp beads 11 to turn off all of them based on said reset command, while controlling said second lamp beads 14 to display zero based on the reset command.

Said step S6 and said step S7 do not have time sequence with said steps S1 to S5, that said step S6 and said step S7 can be carried out at any moment during the process from said step S1 to said step S5, and a user can cancel the timing setup at any time.

It should be noted that the chips provided in this application are only examples, and person skilled in the art can also choose other chips as needed. Further, the prior arts know how to dispose each circuit on said control circuit board 2, and so this application makes no particular elaboration.

The foregoing statement is only some good embodiments of the invention and is not intended to limit the invention. For any modification, equivalent replacement and improvement made within the spirit and principles of the invention shall be included in the protection scope of the invention.

1. A dual display timer, comprising: a main body and in which there are a control circuit board and a reminder device; the reminder device and the control circuit board are electrically connected, characterized in that, further comprising:
a first display area, the first display area is disposed on front face of the main body, and the first display area further comprises an encoder, a plurality of first lamp beads and a first bezel; the encoder is disposed on the control circuit board; a plurality of the first lamp beads are arranged to circling the encoder on the control circuit board; the first bezel has a plurality of through-holes arranged in a circling way, and the first bezel is disposed on the control circuit board and makes every the first lamp bead emit light outward through corresponding the through-hole;
a second display area, the second display area is disposed on front face of the main body, the second display area comprises a plurality of second lamp beads and a second bezel; a plurality of the second lamp beads is arranged on the control circuit board in the style of digital tubes; on the second display area there are a plurality of slots corresponding to the second lamp beads one by one; the second bezel is disposed on the control circuit board and makes every second lamp bead emit light outward through corresponding the slots to display digitals.

2. The dual display timer of claim 1, wherein the first bezel and the second bezel are integrally connected as a whole piece.

3. The dual display timer of claim 1, wherein the front end of the main body is disposed with a transparent cover plate, and the transparent cover plate covers the first display area and second display area; the encoder's rotary axis sticks out through the first bezel and the transparent cover plate.

4. The dual display timer of claim 1, wherein the main body contains a battery, and the battery connects to the control circuit board.

5. The dual display timer of claim 4, wherein the control circuit board is disposed with a main control circuit, a power supply circuit, an encoder circuit, a reminder circuit, a driver circuit and a display circuit; the power supply circuit, the encoder circuit, the reminder circuit, the driver circuit and the display circuit are all connected to the main control circuit; the reminder circuit, the driver circuit and the display circuit are all connected to the power supply circuit; the display circuit is connected to the driver circuit.

6. The dual display timer of claim 5, wherein the main control circuit comprises a main control chip, the power supply circuit comprises the battery, and the twenty-third pin of the main control chip is connected to the battery.

7. The dual display timer of claim 6, wherein the reminder circuit comprises the reminder device and a reminder switch, the positive pole of the reminder device is connected to the battery, the negative pole of the reminder device is connected to the collector of the reminder switch, and the base pole of the reminder switch is connected to the third pin of the main control chip.

8. A control method of dual display timer applied to the dual display timer stated in claim 1, comprising the following steps:
Step S1: the control circuit board obtains the rotation control data of the encoder, and generates the current timing setup based on the rotation control data;
Step S2: the control circuit board generates a first control instruction and a second control instruction based on the current timing setup;
Step S3: the control circuit board sends the first control instruction to the first lamp bead, and controls each the first lamp bead to display the current timing setup based on the first control instruction, then synchronously displays the remaining time of timing setup in the process of counting down to zero from the current timing setup;
Step S4: the control circuit board sends the second control instruction to each the second lamp bead, and controls each the second lamp bead to display zero based on the second control instruction, then synchronously displays the accumulated time of timing setup in the process of counting up to the current timing setup from zero.

9. The control method of dual display timer of claim 8, further comprising:
Step S5: the reminder device is turned on when the current timing setup runs out.

10. The control method of dual display timer of claim 9, further comprising:
Step S6: the control circuit board obtains a reset command that triggers the encoder;
Step S7: the control circuit board sends a reset command to the first lamp beads and the second lamp beads, and controls all the first lamp beads to turn off based on the reset command, while controlling each the second lamp bead to display zero based on the reset command.
